(19) United States
(12) Patent Application Publication
(10) Pub. No.: US 2026/0236409 A1
(43) Pub. Date: Aug. 13, 2026

(54) ACCELERATING CONTAINER INITIATION IN PRODUCTION ENVIRONMENTS

(71) Applicant: Microsoft Technology Licensing, LLC, REDMOND, WA (US)

(72) Inventors: Yi Jun LIU, Renton, WA (US); Esteban REY LONDONO, Redmond, WA (US); Aviral TAKKAR, Bellevue, WA (US); Sajay ANTONY, Woodinville, WA (US); Bin DU, Redmond, WA (US); Jason Yan Ching PANG, Seattle, WA (US); Yi Ming XU, Vancouver (CA)

(21) Appl. No.: 19/048,712

(22) Filed: Feb. 7, 2025

(51) Int. Cl. G06F 13/20

(52) U.S. Cl. CPC G06F 13/20; G06F 2213/40

(57) ABSTRACT

Methods, apparatuses, and products for accelerating container initiation in production environments, including: identifying, based on one or more input/output (I/O) operations associated with a container that are issued in the production environment, a one or more data extents that is sufficient for a host operating system to initiate the container; and responsive to a request to initiate the container, providing the one or more data extents, wherein the host operating system can initiate the container based on the provided one or more data extents without additional portions of a complete dataset for the container being provided to the host operating system.

### BACKGROUND

Modern computer systems frequently involve container-based architectures in which software applications can execute within software containers. A software container can provide an isolated execution environment for executing an application whereby multiple instances of an application can be deployed using multiple separate containers. Executing an application using a container can involve first deploying the container in a computing environment that can serve as a host computer system for the container. A container may include several components, including a file system that is transferred to the host computer system as part of initiating or starting up the container. The file system of the container may comprise several layers that are typically stored as compressed archives. These layers are provided to the host computer system from a remote source and decompressed at the host computer system before an application can make use of the container to execute the application's operations within the container.

Known methods for initiating a container can be time-consuming and resource-intensive, such as methods that involve downloading multiple layers from the remote source, decompressing each layer, and extracting their contents to a location in the host's file system. Some known methods such as container data streaming can reduce some resource usage by directly streaming portions of the container data (e.g., portions of different layers) uncompressed to the host computer system on demand. However, streaming several container data portions in this manner can lead to network bottlenecks since the number of portions required for container startup may be large, resulting in a large number I/O requests to the remote source that network congestion between the host computer system and the remote source. Additionally, these methods may result in the host computer system receiving fragmented data from the remote source, since the data may be requested in a manner that follows the request patterns of the host computer system, for portions of the different container layers, which may be random. Furthermore, known container streaming methods may require separate offline processes for determining what container data portions are to be obtained before applying these offline determinations to a production container deployment.

### SUMMARY

According to embodiments of the present disclosure, various methods, apparatus, and products for accelerating container initiation in production environments are described herein. In some aspects, the methods include identifying, based on one or more input/output (I/O) operations associated with a container that are issued in the production environment, a one or more data extents that is sufficient for a host operating system to initiate the container; and responsive to a request to initiate the container, providing the one or more data extents, wherein the host operating system can initiate the container based on the provided one or more data extents without additional portions of a complete dataset for the container being provided to the host operating system. In some aspects, an apparatus may include a memory and one or more processing devices, operatively coupled to the memory, the one or more processing devices configured to perform similar steps. In some aspects, a computer program product comprising a computer readable storage medium may store computer program instructions that, when executed, perform similar steps.

### BRIEF DESCRIPTION OF DRAWINGS

FIG. 1 sets forth an example system for accelerating container initiation in production environments in accordance with some embodiments of the present disclosure.

FIG. 2 sets forth a flow chart illustrating an example method for accelerating container initiation in production environments in accordance with some embodiments.

FIG. 3 sets forth a flow chart illustrating an example method for accelerating container initiation in production environments in accordance with some embodiments.

FIG. 4 sets forth a flow chart illustrating an example method for accelerating container initiation in production environments in accordance with some embodiments.

FIG. 5 sets forth a flow chart illustrating an example method for accelerating container initiation in production environments in accordance with some embodiments.

FIG. 6 sets forth a flow chart illustrating an example method for accelerating container initiation in production environments in accordance with some embodiments.

FIG. 7 sets forth a flow chart illustrating an example method for accelerating container initiation in production environments in accordance with some embodiments.

FIG. 8 sets forth a flow chart illustrating an example method for accelerating container initiation in production environments in accordance with some embodiments.

FIG. 9 sets forth a flow chart illustrating an example method for accelerating container initiation in production environments in accordance with some embodiments.

FIG. 10 sets forth an example of a computing device that may be used for some portion of accelerating container initiation in production environments in accordance with some embodiments.

FIG. 11 sets forth a block diagram of a cloud services provider service architecture in accordance with some embodiments of the present disclosure.

### DESCRIPTION OF EMBODIMENTS

Containerized software deployment offers numerous advantages relative to traditional software deployment models, including portability across environments, efficient resource utilization, and support for orchestration at scale. However, the process of downloading and initializing containerized applications can pose significant challenges. Downloading and initializing containerized applications often requires substantial system resources, consumes considerable bandwidth, and introduces delays that can degrade performance and user experience.

To address these issues, containerized software deployment can be streamlined by focusing on the selective retrieval of essential data required for container initialization. Rather than downloading the full contents of a container image before container startup, the specific subset of data necessary to begin container execution can be identified and fetched. By prioritizing the retrieval of the data that is essential to instantiate a container, delays are minimized, and containers can begin operating more rapidly relative to other containerized software deployment models.

In order to identify the data that is needed to instantiate a container, profiling processes may be carried out where container data access patterns during initialization are profiled. These profiling processes can passively monitor a system as it loads and executes containers in real-world scenarios, thereby identifying which data elements are consistently accessed during the startup process. Such information may be stored as a usage profile that can serve as a blueprint for future deployments. When an additional instance of the container is subsequently deployed, the system may leverage the usage profile to prefetch and prioritize the retrieval of the required data, ensuring a faster startup process relative to other containerized software deployment models.

In addition to profiling, systems may incorporate local caching mechanisms to enhance efficiency further. In these embodiments, frequently accessed data can be cached, thereby reducing the need for repeated network requests. This approach can minimize bandwidth usage and accelerate container initialization by ensuring that commonly required data is immediately available. In some embodiments, these improvements are implemented in a manner that is transparent to end users. Applications and deployment workflows therefore may not require modification, allowing organizations to benefit from improved performance without additional configuration or complexity.

By leveraging real-time analysis, profiling, and optimization techniques, the approaches set forth herein can be used to improve container startup times relative to other deployment models. Once profiling data is gathered for a container, the profiling data can be used again and again for future requests to initiate the container, thereby continuously improving container startup times relative to other deployment models.

Through the usage of the techniques described here, users that deploy containerized software applications in environments as described here may experience faster startup times for their containerized applications relative to environments that leverage other deployment models. Users that deploy containerized software applications in environments as described here may also experience an increase in the availability their containerized software applications, as recovery from failure events may occur more rapidly as compared to other environments that leverage other deployment models. By improving startup times and increasing availability for containerized applications, software developers may prefer to deploy their applications in environments that implement the techniques described here, thereby leading to greater adoption of those environments. Where those environments are provided by a cloud service provider, the techniques described here may lead to greater adoption of the services offered by such a cloud services provider.

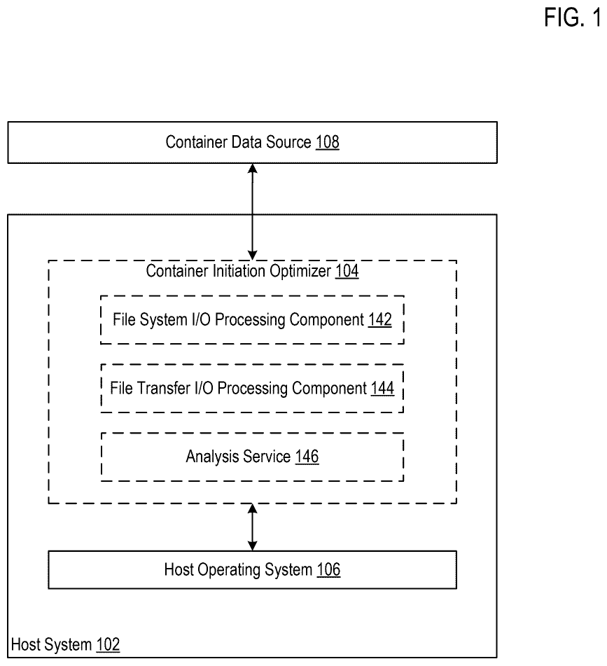

For further explanation, FIG. 1 sets forth an example system for accelerating container initiation in production environments in accordance with some embodiments of the present disclosure. The example depicted in FIG. 1 includes a host system 102 that can be used to support the execution of one or more containerized software applications. The host system 102 can include a set of hardware and/or software resources used to host one or more containers that are initiated or deployed using container data. In some embodiments, the host system 102 obtains container data as part of a process to deploy containers, manage containers, or perform other container-related actions.

As used herein, the term container data can refer to components of a container that may be packaged as a file system that contains one or more files, libraries, binaries, and other configurations and components needed to run a containerized application. In some implementations, a container may be packaged as a content addressable file system that can be transferred to a platform agnostic host system. A container may be stored as one or more layers representing different portions of the file system, where each layer can include, for example, a compressed archive. Container data can therefore include some or all of the file system, including one or more of the layers.

In some embodiments, one or more layers can include base image files as well as other libraries and/or binaries that include executable files usable to run various programs. Additional content such as dependency data, configuration files, environment variable data, and/or namespace or isolation data (e.g., namespaces for different processes, a network stack namespace, a file system namespace, a user namespace, and so on) may be included in one or more layers of the container's file system.

The container data can also include tags specifying the version of a container image. Some or all of the abovementioned layers may comprise read-only container data. The container data can also include a writable upper layer that may be added during a container's runtime. The layers may also represent changes or additions made to the container's file system. In some embodiments, some of the abovementioned components may also be referred to as container artifacts.

The example depicted in FIG. 1 also includes a container data source 108. The container data source 108 may be a repository or registry of container data that can be transferred (e.g., downloaded or streamed) to the host system 102 as part of a container deployment process. The container data source 108 can respond to I/O requests, such as file transfer I/O requests or stream I/O requests, with requested data such as container file system layers or other artifacts. The container data source 108 can, for example, stream all or part of one or more layers associated with the host system 102.

The host system 102 can also include a host operating system 106. The host operating system 106 may execute on a physical or virtual machine on which a container is deployed. Containers may share the kernel of the host operating system 106 while also providing user space isolation. The host operating system 106 can be configured to issue file system I/O requests for container data, such as a request for one or more data extents used to initiate a container.

In some embodiments, the container initiation optimizer 104 of the host system 102 is configured to optimize the initiation process for a container by performing various actions that reduce the amount of time or resources required to start up a container on the host system 102. Container initiation may involve the host operating system 106 obtaining container data and initiating the container using the obtained container data. In some embodiments, the container initiation optimizer 104 optimizes the initiation process for the host operating system 106 by providing, to the host operating system 106, a subset of container data (e.g., one or more data ranges or data extents) that is less than a complete container data set. The container initiation optimizer 104 may identify the subset of container data as being sufficient for starting the container without downloading additional portions of the complete container data set.

The following paragraphs describe the functionality of various components depicted in FIG. 1 as these components identify and obtain the subset of container data (e.g., a set of data extents) that is sufficient to the start the container on a host operating system 106. Starting the container, including situations where the host operating system 106 is creating a first instance of the container, can involve the host operating system 106 issuing a series of ‘range’ requests to the remote host where the layers of the container reside. The ‘range’ requests may indicate an offset/length, also referred to as a ‘data extent’, from the layer to serve back to the host operating system 106. As will be described in greater detail in this disclosure, the components described below can determine the data extents that are used in container initiation, generate profiling data for the container that identifies this subset of container data, and then use the profiling data to obtain the requested data extents from a data source such as the container data source 108. The obtained data extents can be provided to the host operating system 106 for initiating a first instance of the container.

While some embodiments described herein relate to the initiation of a first instance of a container by host operating system 106, the data extents that are obtained by the host operating system 106 can be downloaded or cached for future use, such as to fulfill subsequent requests to initiate subsequent instances of the same container. Accordingly, while the following paragraphs describe a process involving initiation of a first instance of a container, steps of this process may be streamlined or omitted when initiating subsequent instances of the same container. As a result, additional usage of compute, storage, or network resources may be reduced or avoided.

In some embodiments, the container initiation optimizer 104 includes a file system I/O processing component 142. The file system I/O processing component 142 can process file system I/O requests that are issued, for example, from a host operating system 106. At least some of these file system I/O requests may be requests associated with the operation of a container, such as requests to initiate a container, where at least some of these requests also indicate particular container data portions that host operating system 106 for use in container initiation processes.

In some embodiments, the file system I/O processing component 142 can be configured to analyze the file system I/O requests from the host operating system 106. Analyzing the file system I/O requests from the host operating system 106 can include, for example, identifying any file system I/O requests that are related to container initiation. Such file system I/O requests that are related to container initiation are therefore distinguished (e.g., by the file system I/O processing component 142) from other file system I/O requests. For example, the host operating system 106 can indicate, via a file system I/O request or otherwise, that the host operating system 106 will begin deployment of a container on the host system 102. Based on such an indication, the file system I/O processing component 142 can treat incoming file system I/O requests as being related to container initiation. The file system I/O processing component 142 can subsequently analyze incoming file system I/O requests for the presence of data extent identifiers (e.g., offset or length values associated with a layer of the container file system). Moreover, the file system I/O processing component 142 can identify such requests as being related to container initiation for a specific container by examining other data or metadata contained in a request (e.g., an identifier for the container, an identifier of an image associated with the container). In some cases, this process may be referred to as container profiling and the output may be referred to as profiling data for the specific container.

In some embodiments, the file system I/O processing component 142 can be configured to service file system I/O requests for container data in a virtualized I/O processing environment. In virtualized I/O processing, a virtualization layer may be created between an issuer of I/O requests such as the host operating system 106 and storage resources that provide content in response to such I/O requests. In cases where file system I/O is virtualized, storage resources (e.g., sources of container data for container initiation) may appear as if the storage resources were local to the host operating system 106. In such cases, the I/O request patterns of the host operating system 106 may involve the host operating system 106 making a relatively large number of I/O requests for relatively small data chunks. This may occur when the host operating system 106 expects storage resources to be local, such that low-latency access is possible. However, in the container initiation scenarios described herein, container data may be obtained through streaming I/O processing from non-local storage resources such as the container data source 108, which may be remote from host system 102. Streaming I/O processing may be configured for different I/O request patterns involving relatively fewer I/O requests for relatively larger data chunks. In such scenarios, the file system I/O processing component 142 can be configured to service the relatively large number of file system I/O requests issued from the host operating system 106 for container data by providing data that was obtained from remote sources via streaming I/O processes.

The container initiation optimizer 104 can also include an analysis service 146. The analysis service 146 may be configured to receive metadata of file system I/O requests from the file system I/O processing component 142 and associate the metadata with a container. In some embodiments, the analysis service 146 can store identifiers for different containers and associations between the identified containers and different metadata from file system I/O requests that is received from the file system I/O processing component 142. The analysis service 146 can use, for example, profiling data provided from the file system I/O processing component 142 and associate it with a particular container. Such associations may be stored, for example, in a database or other data structure. In some embodiments, the analysis service 146 can collect identifiers for all data extents that were requested for initiation of a particular container based on analysis of one or more file system I/O requests. The analysis service 146 may label a set of these identified data extents as the minimum set of data extents that is sufficient to initiate the associated container. As an example, the analysis service 146 may label the set of identified data extents (or a container initiation set) for a container A as “container initiation set-container A”.

In some embodiments, the container initiation optimizer 104 includes a file transfer I/O processing component 144. The file transfer I/O processing component 144 can be configured to send file transfer I/O operations 171 to the container data source 108, as part of an effort to acquire the identified set of data extents (i.e., the data extents needed to initiate a container). The file transfer I/O processing component 144 may obtain information describing the data extents needed to initiate a particular container from the analysis service 146. The file transfer I/O processing component 144 can use such information to request the identified set of data extents from the container data source 108. The file transfer I/O processing component 144 may subsequently obtain the identified set of data extents using, for example, container streaming (or container artifact streaming) facilities offered by the container data source 108.

The file transfer I/O processing component 144 can also be configured to download or cache the identified set of data extents for future use. For example, after a first startup of a container A, the file transfer I/O processing component 144 can download or cache all of the identified set of data extents for container A (e.g., the data extents labeled as “container initiation set—container A”). When there is a subsequent request from the host operating system 106 to initiate another instance of container A, the file transfer I/O processing component 144 can provide the set of identified data extents in response to the subsequent request.

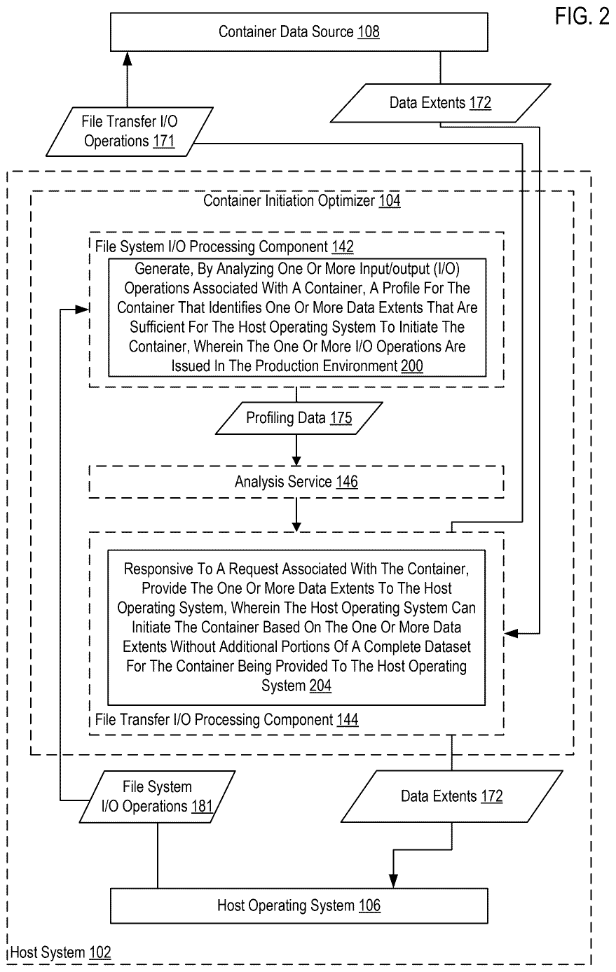

For further explanation, FIG. 2 sets forth a flow chart illustrating an example method for accelerating container initiation in production environments in accordance with some embodiments. The method of FIG. 2 may be performed in a system as depicted in FIG. 1, or by another computing system or computing environment as can be appreciated.

The method of FIG. 2 includes generating 200, by a container initiation optimizer 104 analyzing one or more I/O operations 181 associated with a container, a profile for the container that identifies one or more data extents 172 that are sufficient for the host operating system 106 to initiate the container. The profile for the container may be embodied, for example, as a data structure that includes information related to initiating the container. The profile may include, for example, information describing which data extents 172 are needed for a host operating system 106 to initiate the container, information describing where to find such data extents 172, and other information that may be useful when initiating the container. In FIG. 2, the one or more I/O operations 181 may be issued in a production environment. In such a way, the profile for the container may be generated 200 based on actual computing activity in a production environment, rather than based on a simulation or similar mechanism.

In the method of FIG. 2, the container initiation optimizer 104 may analyze one or more I/O operations 181 associated with a container to identify one or more data extents 172 that are sufficient for a host operating system 106 to initiate the container. Identifying the data extents 172 that are sufficient for the host operating system 106 to initiate a container may be carried out, for example, by determining that host operating system 106 has begun a container initiation process and subsequently analyzing file system I/O operations 181 issued by host operating system 106 during the container initiation process. In such a way, the file system I/O processing component 142 may assume that file system I/O operations 181 that are initiated by the host operating system 106 while the host operating system 106 is initiating a container are directed to the data extents that are needed for the host operating system 106 to initiate the container. Once the container has been successfully initiated, however. the file system I/O processing component 142 may assume that any file system I/O operations 181 initiated by the host operating system 106 after the container has been successfully initiated are not directed to data extents that are needed to initiate the container. In such an example, the container status may be inspected to determine whether a container is in the process of being initiated (i.e., the container status is ‘created’) or whether the container has been fully initiated (i.e., the container status is ‘running’). The status of the container may be checked, for example, using Docker commands that return container status, using containerd commands that return container status, using Kubernetes commands that return container status, by inspecting container logs, or in some other way.

In some embodiments, the file system I/O processing component 142 or some other component of the container initiation optimizer 104 can generate 200 a profile (depicted here as profiling data 175) that identifies the data extents that are needed to initiate the container. The file system I/O processing component 142 can generate the profiling data 175 for later use as described in greater detail elsewhere in the present disclosure. The profiling data 175 may include information identifying the data extents 172 that are needed to initiate the container, information identifying data extents that are not necessary for initiating a container, or other information. Readers will appreciate that the host operating system 106 may send a number of file system I/O operations 181 to the file system I/O processing component 142. Some of these file system I/O operations 181 may request data extents that are involved in container startup for a container. Other file system I/O operations 181 may request data that is not necessary for starting the container. For example, the host operating system 106 may issue other file system I/O operations 181 for additional portions of the container's data that are not used in startup of the container. As another example, the host operating system 106 may issue other file system I/O operations 181 for container data for other containers that are already initiated or are not being initiated at this time. Likewise, the host operating system 106 may issue file system I/O operations 181 that are not related to container initiation at all. The file system I/O processing component 142 may select the file system I/O operations 181 that pertain to container startup for a container, and generate profiling data for the container that includes the data extents required for the container to start. These data extents may also be referred to herein as a container initiation set. In some embodiments, the file system I/O processing component 142 can send the profiling data 175 to the analysis service 146, such that the analysis service 146 can store a mapping between a container and its profiling data.

The method of FIG. 2 also includes providing 204, by the file transfer I/O processing component 144 to the host operating system 106, the data extents 172 needed to initiate the container that were identified in the profile for the container. The file transfer I/O processing component 144 may provide 204 the data extents needed to initiate the container to the host operating system 106 in response to a request from the host operating system 106 to initiate the container. In some embodiments, the host operating system 106 can initiate the container using the data extents 172, and without additional portions of the container data being provided to the host operating system 106. The file transfer I/O processing component 144 may provide 204 the data extents 172 to the host operating system 106, for example, via one or more messages sent from the file transfer I/O processing component 144 to the host operating system 106, by the file transfer I/O processing component 144 writing the data extents to some known location accessible by the host operating system 106, or in some other way.

In some embodiments, the file transfer I/O processing component 144 can receive (e.g., from analysis service 146) information describing the data extents 172 that are sufficient to start up a container. In some embodiments, the file transfer I/O processing component 144 can issue one or more file transfer I/O operations 171 for the data extents 172 to the container data source 108, such that the file transfer I/O processing component 144 can provide 204 the data extents 172 that are needed for to initiate the container to host operating system 106.

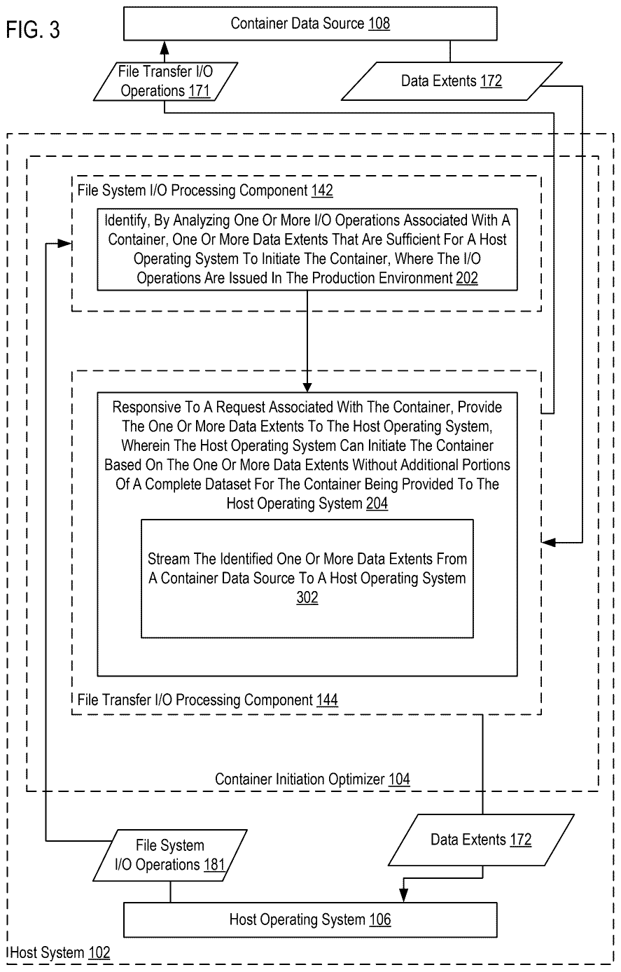

For further explanation, FIG. 3 sets forth a flow chart illustrating an example method for accelerating container initiation in production environments in accordance with some embodiments. The example method depicted in FIG. 3 includes identifying 202, based on one or more I/O operations associated with a container, a one or more data extents 172 that are sufficient for a host operating system 106 to initiate the container. Identifying 202 the data extents 172 that are sufficient for the host operating system 106 to initiate a container may be carried out, for example, by determining that host operating system 106 has begun a container initiation process and subsequently analyzing file system I/O operations 181 issued by host operating system 106 during the container initiation process. In such a way, the file system I/O processing component 142 may assume that file system I/O operations 181 that are initiated by the host operating system 106 while the host operating system 106 is initiating a container are directed to the data extents that are needed for the host operating system 106 to initiate the container. Once the container has been successfully initiated, however. the file system I/O processing component 142 may assume that any file system I/O operations 181 initiated by the host operating system 106 after the container has been successfully initiated are not directed to data extents that are needed to initiate the container. In some embodiments, the file system I/O processing component 142 can identify 202 the data extents that are needed to initiate the container through the use of profiling data 175, as described above.

The example method of FIG. 3 includes streaming 302, from a container data source 108 to a host operating system 106, the one or more data extents 172 that are needed to initiate a container. As described above, containers can be packaged content addressable filesystems, which typically require downloading and decompressing multiple layers before an application can start. In this example, however, streaming 302 the one or more data extents 172 that are needed to initiate a container from the container data source 108 to the host operating system 106 can include streaming uncompressed layers directly to the host operating system 106. Streaming 302 techniques can reduce the initial download costs and overhead associated with pruning unused data.

As is set forth above, the container initiation optimizer 104 may include various components that collectively can process both file system I/O operations 181 to or from host operating system 106 and file transfer I/O operations 171 to or from a container data source 108. The I/O patterns that occur when a host operating system 106 accesses a filesystem (e.g., file system I/O operations 181 to or from host operating system 106) can be meaningfully different than I/O patterns that occur when the host operating system 106 is attempting to transferring files to or from a remote target (e.g., file transfer I/O operations 171 to or from a container data source 108). When transferring files to or from a remote target, the host operating system 106 may be configured to make a relatively small number of requests with larger transfer lengths since the data being transferred is typically not physically located to the host system 102, and each request has networking overhead. When the host operating system 106 is issuing file system I/O operations 181, however, a relatively large number of I/O requests with smaller transfer lengths may be issued since the storage device that houses the file system is frequently on the same host system 102 as the host operating system 106. The container initiation optimizer 104 can resolve this issue by the file system I/O processing component 142 creating profiling data 175 for a container by analyzing file system I/O operations received from host operating system 106. The file system I/O processing component 142 can share the profiling data 175 with the analysis service 146, so that the file transfer I/O processing component 144 can leverage the profiling data to create an aggregated list of data extents that are needed for container initiation. Because the file transfer I/O processing component 144 creates an aggregated list of data extents that are needed for container initiation, rather than just sending individual requests for each of the data extents that are needed for container initiation, the number of file transfer file transfer I/O operations 171 to or from the container data source 108 may be reduced, thereby avoiding delays caused by sending a series of relatively small I/O requests over a network.

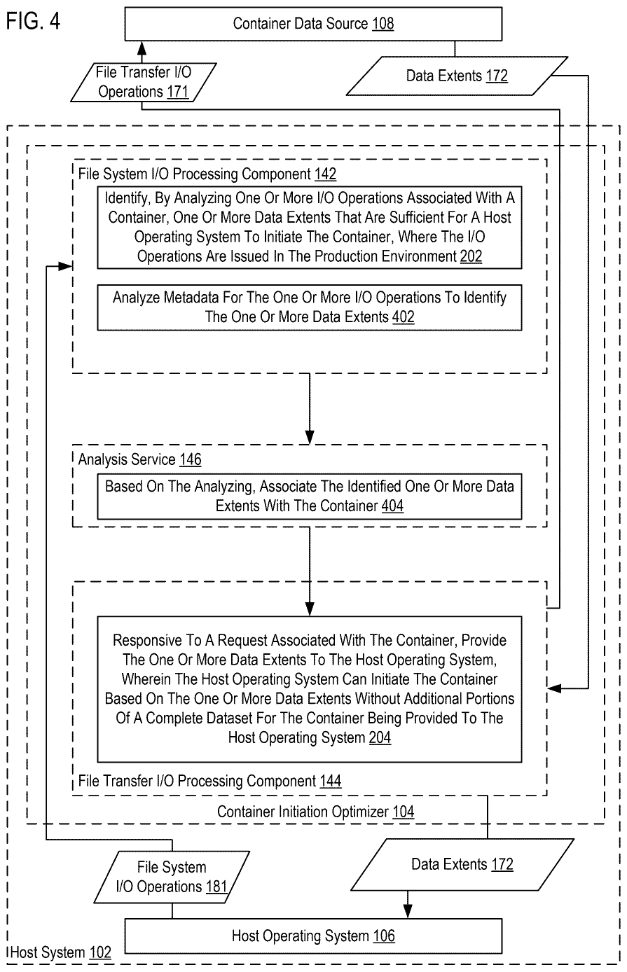

For further explanation, FIG. 4 sets forth a flow chart illustrating an example method for accelerating container initiation in production environments in accordance with some embodiments. The example method of FIG. 4 includes analyzing 402 metadata for the one or more I/O operations 181 to identify the one or more data extents 172 that are sufficient for the host operating system 106 to initiate the container. Analyzing 402 metadata for the one or more I/O operations 181 to identify the one or more data extents 172 can include, for example, analyzing the contents of a file system I/O request packet (‘IRP’) issued by the host operating system 106. The IRP can represent metadata for the one or more I/O operations 181, as the IRP may be embodied as a data structure used by an operating system that contains information about a file system I/O operation. The IRP can include information such as, for example, the operation type (read/write), a file handle, the request target, an offset and length associated with the requested data, a transfer size specifying the amount of data to be read or written, and other information. In this example, the file system I/O processing component 142 or some other component of the container initiation optimizer 104 can identify, from the IRP itself, the data extent that is being requested.

The example method of FIG. 4 also includes based on the analyzing, associating 404 the identified one or more data extents 172 with the container. Associating 404 the identified one or more data extents 172 with the container can include storing, by analysis service 146 of container initiation optimizer 104, an association or mapping between a container identifier and identifiers the one or more data extents 172. Furthermore, associating 404 the identified one or more data extents 172 with the container can also include storing an indication to prefetch the identified one or more data extents 172, or to download and cache the identified one or more data extents 172 locally on the host system 102, such that when subsequent requests are received to initiate the container, additional requests to the container data source 108 may be avoided.

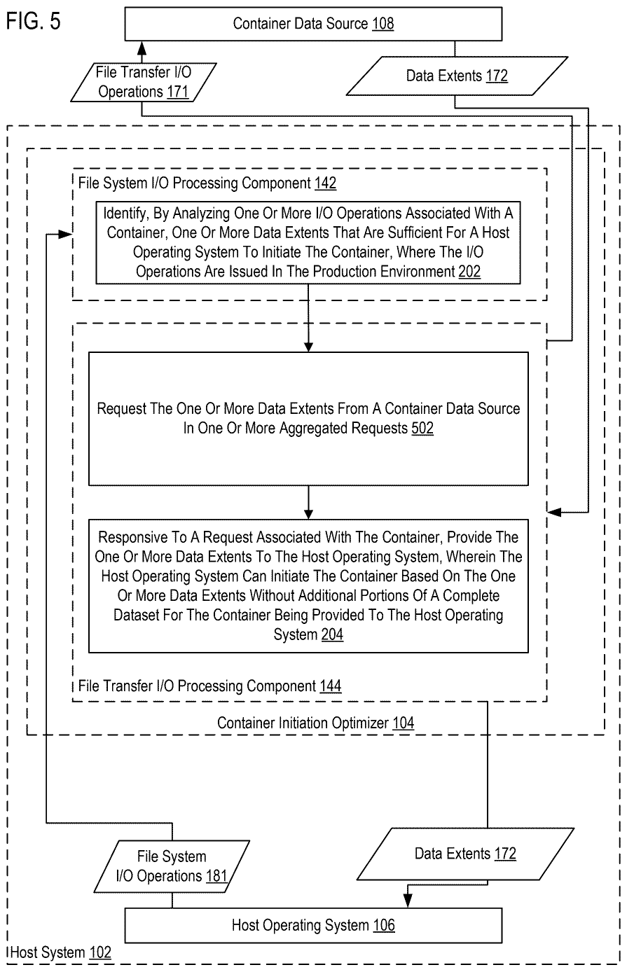

For further explanation, FIG. 5 sets forth a flow chart illustrating an example method for accelerating container initiation in production environments in accordance with some embodiments. The example method of FIG. 5 includes requesting 502 the one or more data extents from a container data source in one or more aggregated requests. In this example, each of the aggregated requests may be embodied as an file transfer I/O operation 171 that is sent from the host system 102 to the container data source 108 over a data communication network. Each aggregated request can include a request for multiple data extents 172 that are needed for the host operating system 106 to initiate the container. Each aggregated request may be generated, for example, based on an aggregated list of the data extents 172 that are sufficient for the host operating system 106 to initiate the container. As described above, such an aggregated list may be created based on profiling data and may be created, for example, by an analysis service or some other module. Through the usage of one or more aggregated requests, network overhead may be avoided as compared to issuing individual network requests for each of the identified data extents (e.g., issuing a request as each data extent 172 that is needed for the host operating system 106 to initiate the container) as those data extents are identified.

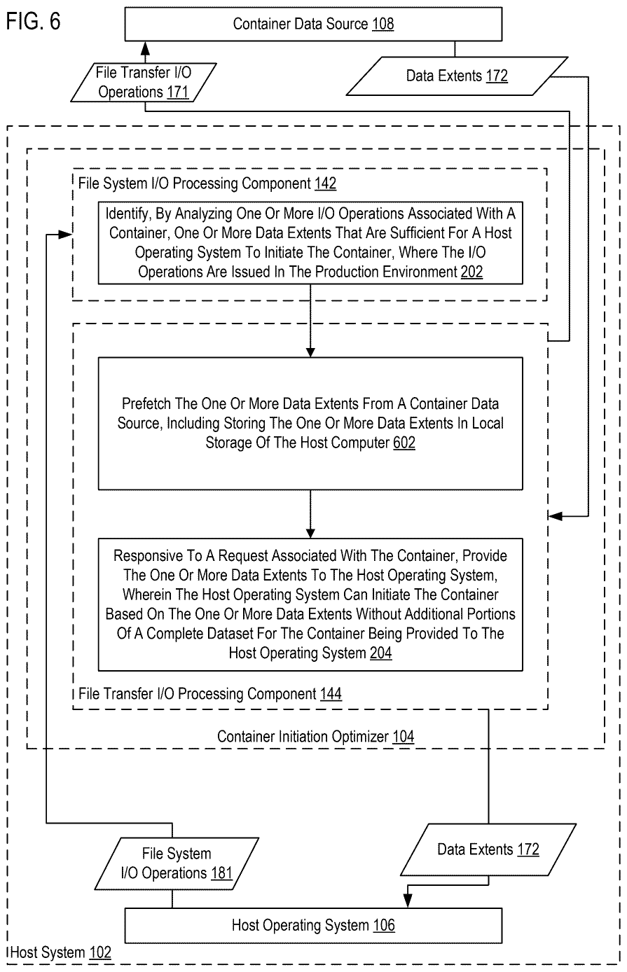

For further explanation, FIG. 6 sets forth a flow chart illustrating an example method for accelerating container initiation in production environments in accordance with some embodiments. The example method of FIG. 6 includes prefetching 602 the one or more data extents 172 from the container data source 108, including storing the one or more data extents 172 in local storage of the host system 102. Prefetching 602 the one or more data extents 172 from the container data source 108 may be carried out, for example, by the file transfer I/O processing component 144 downloading and caching the one or more data extents 172 locally on the host system 102. The one or more data extents 172 may be cached locally on the host system 102, for example, by storing the one or more data extents 172 in local storage of the host system 102. Alternatively, the one or more data extents 172 may be cached locally on the host system 102 by storing the one or more data extents 172 in some other storage (e.g., direct attached storage) that is accessible to host system 102 without traversing a data communications network and instead by using local interconnects or similar mechanisms. To the extent possible, the file transfer I/O processing component 144 can then provide data extents 172 from local storage rather than sending additional requests to container data source 108 for the same data. In fact, the contents of the aggregated requests described above may be impacted by the presence of locally stored data extents, as the aggregated requests may exclude any locally stored data extents. In particular, as the container initiates and the file system I/O processing component 142 begins to service file system I/O requests from host operating system 106, the file transfer I/O processing component 144 can provide the data extents identified by those file system I/O requests from local storage where possible, thereby reducing further network resource usage as the identified one or more data extents 172 have already been obtained.

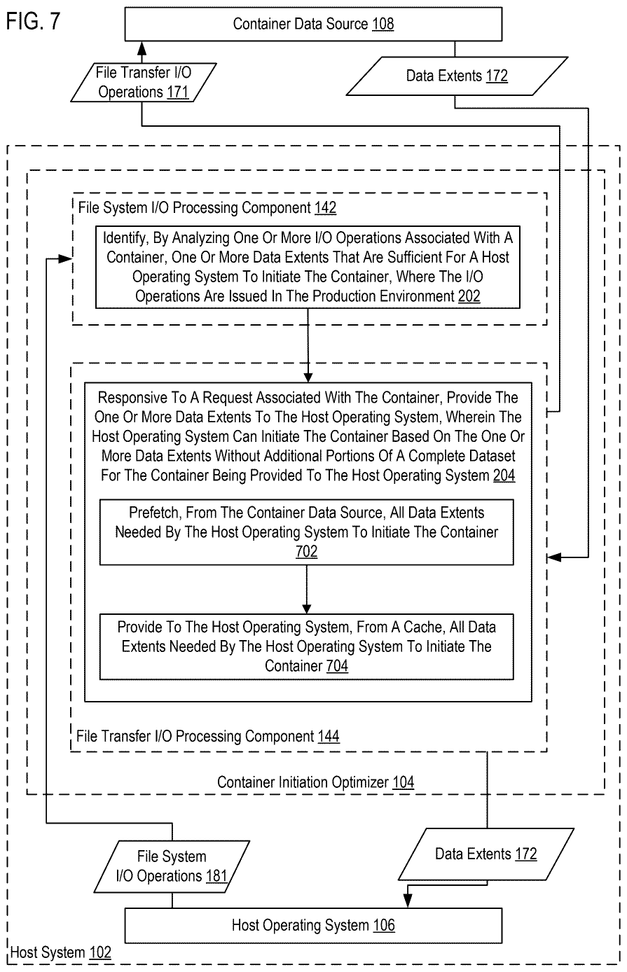

For further explanation, FIG. 7 sets forth a flow chart illustrating an example method for accelerating container initiation in production environments in accordance with some embodiments. The example method of FIG. 7 includes prefetching 702 the one or more data extents from the container data source 108. In this example, prefetching 702 the one or more data extents from the container data source 108 in depicted as being part of providing 204 the data extents 172 needed to initiate the container. In some embodiments, if a request for some subset of the data extents 172 needed to initiate the container is received, all of the data extents 172 needed to initiate the container may be prefetched 702. Prefetching 702 the one or more data extents from a container data source can be carried out, for example, by file transfer I/O processing component 144 prefetching all the data extents that were identified in a container initiation one or more data extents provided by, for example, analysis service 146. In some embodiments, file transfer I/O processing component 144 can prefetch all of the identified one or more data extents and store the prefetched extents in local storage.

The example method of FIG. 7 also includes providing 704 to the host operating system 106, from a cache, all data extents 172 needed by the host operating system 106 to initiate the container. Consider an example where the host operating system 106 requests data extent 1, data extent 2, and data extent 3 as part of a container initiation process for a container A. The file system I/O processing component 142 may identify all three data extents as being data extents that are needed for the host operating system to initiate container A. In this example, the analysis service 146 can create a list of prefetch extents that associates data extent 1, data extent 2, and data extent 3 with container A. The file transfer I/O processing component 144 may then obtain the list of prefetch extents from the analysis service 146, such that the file transfer I/O processing component 144 can then prefetch all three data extents by request the three data extents from the container data source 108 and subsequently storing the three data extents in local storage of the host system 102. The file system I/O processing component 142 can service the host operating system's 106 request for data extent 1 by providing the prefetched data extent 1 that was obtained by the file transfer I/O processing component 144. Readers will appreciate that even as the host operating system 106 receives data extent 1, data extent 2 and data extent 3 are already in local storage and are ready to be provided to the host operating system 106 without additional requests to the container data source 108.

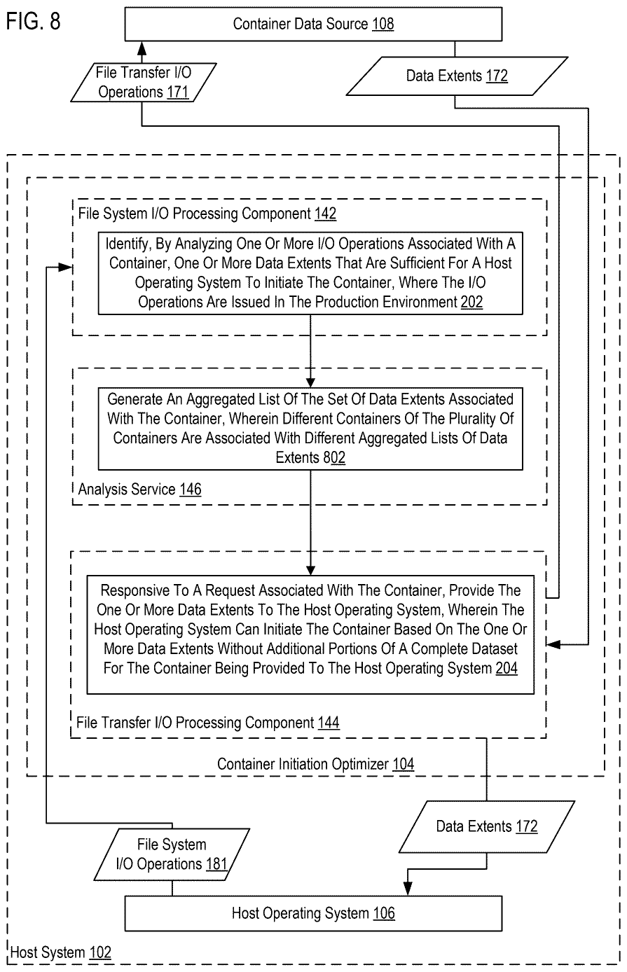

For further explanation, FIG. 8 sets forth a flow chart illustrating an example method for accelerating container initiation in production environments in accordance with some embodiments. The example method of FIG. 8 includes generating 802 an aggregated list of the one or more data extents associated with the container, wherein different containers of the plurality of containers are associated with different aggregated lists of data extents. In some embodiments, generating 802 an aggregated list can be carried out by the analysis service 146. In some embodiments, the analysis service 146 can receive profiling data from the file system I/O processing component 142 that includes identifiers for different data extents (e.g., different offset or length values). The analysis service 146 can generate a single listing of all data extents identified as being involved in container initiation for a particular container, such as container A. When the host operating system 106 requests initiation of container A, the file transfer I/O processing component 144 can use the aggregated list of data extents to obtain the data extents from the container data source 108. In other embodiments, the file system I/O processing component 142 may be configured to generate 802 an aggregated list of the one or more data extents associated with one or more containers itself.

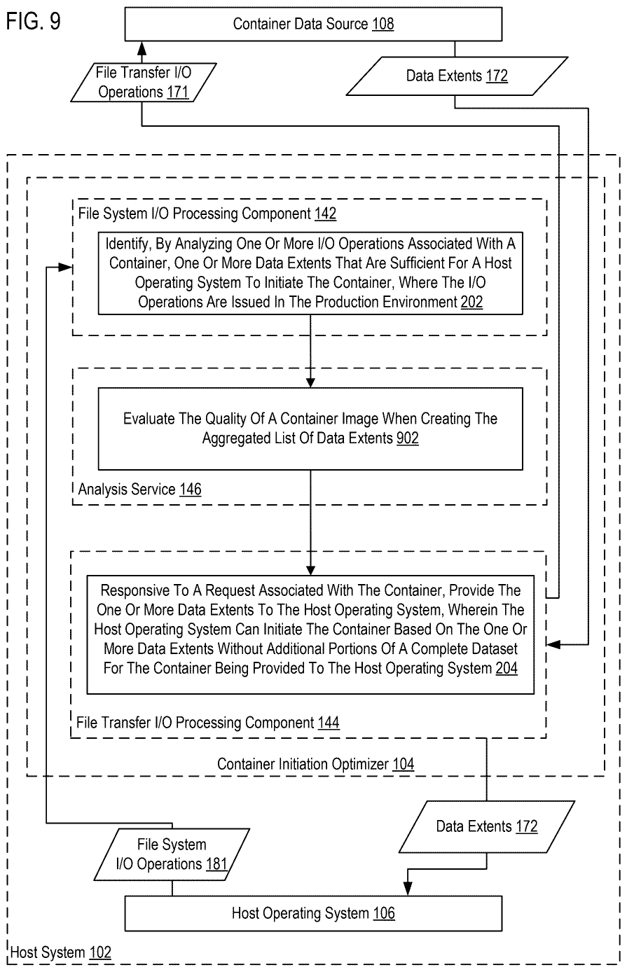

For further explanation, FIG. 9 sets forth a flow chart illustrating an example method for accelerating container initiation in production environments in accordance with some embodiments. The example method depicted in FIG. 9 includes evaluating 902 the quality of a container image when creating the aggregated list of data extents. In some cases, the underlying container image layout may be highly fragmented. This may indicate that the container image quality is degraded or otherwise suboptimal. Where a container image layout is highly fragmented, data extents 172 needed to initiate a container from that container image may be spread across many regions of the container data source 108. In such cases, prefetching these data extents can require transmitting the same or a relatively similar number of requests from file transfer I/O processing component 144 to container data source 108 as would have been transmitted without aggregation. Where the data extents associated with a container are so scattered, the abovementioned aggregation processes may provide little or no optimization benefit. As such, the analysis service 146 (or even the file system I/O processing component 142 in some embodiments) can analyze the data extents 172 that are being requested from the container data source 108 and evaluate a degree to which the source data regions for the data extents are scattered across different locations at the container data source 108. The analysis service 146 can subsequently generate a fragmentation metric representing a level of fragmentation for the container image based on the evaluated degree of diffusion for the requested one or more data extents 172.

In some embodiments, the analysis service 146 can use the fragmentation metric to identify container images whose fragmentation levels are high enough to cause potential bottlenecks in downstream processes, such as customer applications that may use the containers initiated based on these images. In one embodiment, the analysis service 146 can determine that aggregating the requested data extents for the identified container images may not provide optimization benefits. In such cases, the analysis service 146 may decline to aggregate the requested data extents for future initiations of the same container.

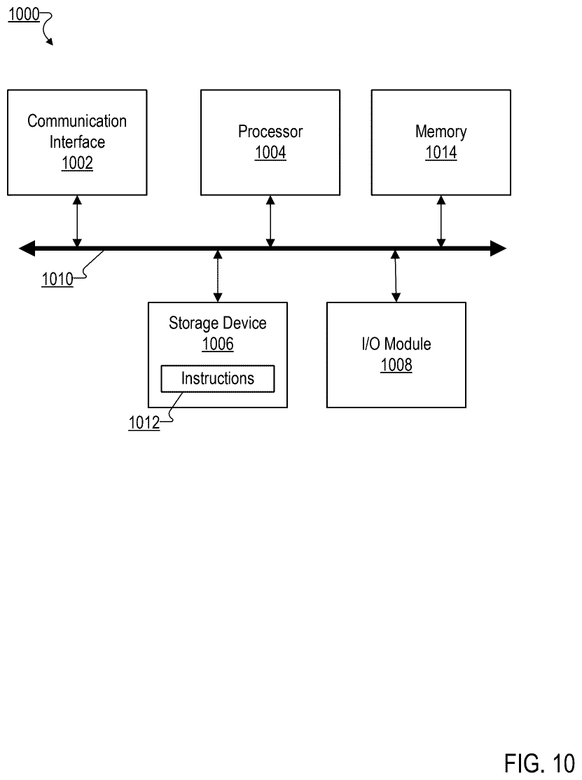

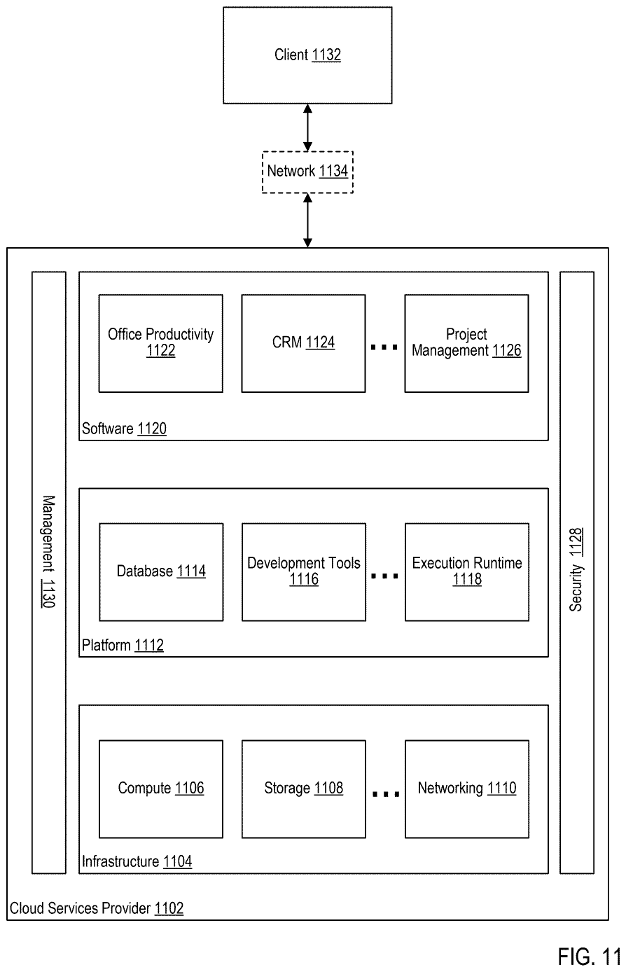

For further explanation, the sections included below provide some details regarding technologies that may be used to support accelerating container initiation in production environments. For example, FIG. 10 sets forth an example of a computing device that may be used for some portion of accelerating container initiation in production environments in accordance with some embodiments. As an additional example of technologies that may be used to support accelerating queries, FIG. 11 sets forth a block diagram of a cloud services provider service architecture in accordance with some embodiments of the present disclosure.

For further explanation, FIG. 10 illustrates an exemplary computing device 1000 that may be specifically configured to perform one or more of the processes described herein. As shown in FIG. 10, computing device 1000 may include a communication interface 1002, a processor 1004, a storage device 1006, an input/output (I/O) module 1008, and computer memory 1014 communicatively connected one to another via a communication infrastructure 1010. While an exemplary computing device 1000 is shown in FIG. 10, the components illustrated in FIG. 10 are not intended to be limiting. Additional or alternative components may be used in other embodiments. Components of computing device 1000 shown in FIG. 10 will now be described in additional detail.

Communication interface 1002 may be configured to communicate with one or more computing devices. Examples of communication interface 1002 include, without limitation, a wired network interface (such as a network interface card), a wireless network interface (such as a wireless network interface card), a modem, an audio/video connection, and any other suitable interface.

Processor 1004 generally represents any type or form of processing unit capable of processing data and/or interpreting, executing, and/or directing execution of one or more of the instructions, processes, and/or operations described herein. Processor 1004 may perform operations by executing computer-executable instructions 1012 (e.g., an application, software, code, and/or other executable data instance) stored in storage device 1006.

Storage device 1006 may include one or more data storage media, devices, or configurations and may employ any type, form, and combination of data storage media and/or device. For example, storage device 1006 may include, but is not limited to, any combination of non-volatile media and/or volatile media. Electronic data, including data described herein, may be temporarily and/or permanently stored in storage device 1006. For example, data representative of computer-executable instructions 1012 configured to direct processor 1004 to perform any of the operations described herein may be stored within storage device 1006. In some examples, data may be arranged in one or more databases residing within storage device 1006.

I/O module 1008 may include one or more I/O modules configured to receive user input and provide user output. I/O module 1008 may include any hardware, firmware, software, or combination thereof supportive of input and output capabilities. For example, I/O module 1008 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 1008 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 1008 is configured to provide graphical data to a display for presentation to a user. The graphical data may be representative of one or more graphical user interfaces and/or any other graphical content as may serve a particular implementation. In some examples, any of the systems, computing devices, and/or other components described herein may be implemented by computing device 1000.

For further explanation and as an additional example of a supporting technology for accelerating container initiation in production environments, FIG. 11 sets forth a block diagram of a cloud services provider service architecture in accordance with some embodiments. The cloud services provider 1102 can deliver a variety of resources through a services-based consumption model where resources are consumed on-demand and as-a-service by, for example, client 1132 via network 1134.

FIG. 11 depicts an embodiment where software 1120 is delivered as a service. Software-as-a-service (‘SaaS’) is a model where software applications are delivered over the internet as-a-service. Rather than installing and maintaining software locally, users can access software via a web browser or other network connected interface, eliminating the need for complex software and hardware management on the client-side. In FIG. 11, as examples of software 1120 that can be delivered as-a-service, the illustrated embodiment includes office productivity 1122 software, customer relationship management (‘CRM’) 1124 software, and project management 1126 software. The office productivity 1122 software can include applications designed to facilitate common business and personal tasks, including word processing applications, applications for spreadsheet creation, presentation design applications, and many others. The CRM 1124 software can include applications for managing a business organization's relationships and interactions with customers and potential customers. The project management 1126 software can include applications designed to help teams plan, organize, and manage projects efficiently by facilitating collaboration and tracking the progress of projects. Readers will appreciate that in other embodiments, other types of software may be delivered using a SaaS model.

FIG. 11 depicts an embodiment where platforms 1112 can be delivered as a service. Platform-as-a-service (‘PaaS’) is a model that provides cloud customers with platform resources that they can use to develop, run, and manage applications without the complexity of such deploying and managing such infrastructure on their own. In FIG. 11, as examples of platform 1112 resources that can be delivered as-a-service, the illustrated embodiment includes database 1114 services, development tools 1116 services, and execution runtime 1118 services. The database 1114 services can be used to provide access to databases without management overhead for the user as the cloud services provider manages the provisioning, scaling, and maintenance of the databases. The development tools 1116 services can provide developers with tools to design, develop, test, and deploy applications without needing to manage the underlying infrastructure. The execution runtime 1118 services can provide environments where applications or other forms of computer program code can be executed, including services to scale the execution environment. Readers will appreciate that in other embodiments, other platform resources may be delivered using a PaaS model.

FIG. 11 depicts an embodiment where infrastructure 1104 can be delivered as a service. Infrastructure-as-a-Service (‘IaaS’) is a model that provides virtualized computing resources over the internet, such that infrastructure such as servers, storage, networks, and others may be leased on demand rather than purchasing and maintaining physical hardware. In FIG. 11, as examples of infrastructure 1104 resources that can be delivered as-a-service, the illustrated embodiment includes compute 1106 services, storage 1108 services, and networking 1110 services. The compute 1106 services can be used to provide on-demand access to computational resources such as VMs, containers, and serverless functions, where the cloud services provider manages the provisioning, scaling, and maintenance of such resources. The storage 1108 services can provide storage resources that can be used to store and access data, without the need for customers to purchase and manage on-premises physical storage resources. The networking 1110 services can provide the ability to create and manage virtualized networking resources such as, for example, virtual private networks (‘VPNs’), firewalls, load balancers, and more. Readers will appreciate that in other embodiments, other infrastructure resources may be delivered using a PaaS model.

The cloud services provider of FIG. 11 also provides management 1130 resources. The management 1130 resources can include, for example, tools and interfaces that enable customers to efficiently deploy, monitor, and manage, their cloud services. Such tools can include web-based management consoles, command-line interfaces (‘CLIs’), APIs, automation tools, and other tools.

The cloud services provider of FIG. 11 also provides security 1128 resources. The security 1128 resources can include, for example, tools and services to help customers protect their cloud environments and ensure compliance with security standards. These tools and services may provide specific aspects of security, including identity and access management, network security, threat detection, compliance management, and others.

Advantages and features of the present disclosure can be further described by the following statements:
1. A method of accelerating container initiation in a production environment that includes a host system that supports a host operating system, the method comprising: generating, by a container initiation optimizer analyzing one or more input/output (I/O) operations associated with a container, a profile for the container that identifies one or more data extents that are sufficient for the host operating system to initiate the container, wherein the one or more I/O operations are issued in the production environment; and responsive to a request to initiate the container, providing the one or more data extents to the host operating system, wherein the host operating system can initiate the container based on the one or more data extents without additional portions of a complete dataset for the container being provided to the host operating system.
2. The method of any combination of one or more of the statements above, wherein the container initiation optimizer includes a file system I/O processing component that processes I/O operations and a file transfer I/O processing component that processes file transfer I/O operations to provide one or more data extents to the host operating system from a container data source; and providing the one or more data extents further comprises streaming the one or more data extents from the container data source to the host operating system.
3. The method of any combination of one or more of the statements above, further comprising analyzing metadata for the one or more I/O operations to identify the one or more data extents that are sufficient for the host operating system to initiate the container; and associating the identified one or more data extents with the container.
4. The method of any combination of one or more of the statements above, further comprising requesting the one or more data extents from a container data source in one or more aggregated requests.
5. The method of any combination of one or more of the statements above, wherein each of the one or more aggregated requests includes an identification of multiple data extents and each aggregated request is generated based on an aggregated list of the one or more data extents that are sufficient for the host operating system to initiate the container.
6. The method of any combination of one or more of the statements above, further comprising prefetching the one or more data extents from a container data source, including storing the one or more data extents in local storage of the host system.
7. The method of any combination of one or more of the statements above, wherein providing the one or more data extents to the host operating system further comprises prefetching, from a container data source, all data extents needed by the host operating system to initiate the container; and providing to the host operating system, from a cache, all data extents needed by the host operating system to initiate the container.
8. The method of any combination of one or more of the statements above, further comprising generating an aggregated list of the one or more data extents associated with each of a plurality of containers, wherein different containers of the plurality of containers are associated with different aggregated lists of data extents.
9. An apparatus for accelerating container initiation in a production environment that includes a host system that supports a host operating system, comprising: a memory; and a processing device, operatively coupled to the memory, the processing device configured to identify, by a container initiation optimizer analyzing one or more input/output (I/O) operations associated with a container, one or more data extents that are sufficient for the host operating system to initiate the container, wherein the one or more I/O operations are issued in the production environment; and responsive to a request to initiate the container, provide the one or more data extents to the host operating system, wherein the host operating system can initiate the container based on the one or more data extents without additional portions of a complete dataset for the container being provided to the host operating system.
10. The apparatus of any combination of one or more of the statements above, wherein the container initiation optimizer includes a file system I/O processing component that processes I/O operations and a file transfer I/O processing component that processes file transfer I/O operations to provide one or more data extents to the host operating system from a container data source; and wherein to provide the one or more data extents, the processing device is further configured to stream the one or more data extents from the container data source to the host operating system.
11. The apparatus of any combination of one or more of the statements above, wherein the processing device is configured to analyze metadata for the one or more I/O operations to identify the one or more data extents that are sufficient for the host operating system to initiate the container; and associate the identified one or more data extents with the container.
12. The apparatus of any combination of one or more of the statements above, wherein the processing device is configured to request the one or more data extents from a container data source in one or more aggregated requests.
13. The apparatus of any combination of one or more of the statements above, wherein each of the one or more aggregated requests includes an identification of multiple data extents and each aggregated request is generated based on an aggregated list of the one or more data extents that are sufficient for the host operating system to initiate the container.
14. The apparatus of any combination of one or more of the statements above, wherein the processing device is configured to prefetch the one or more data extents from a container data source, including storing the one or more data extents in local storage of the host system.
15. The apparatus of any combination of one or more of the statements above, wherein to provide the one or more data extents the processing device is configured to prefetch, from a container data source, all data extents needed by the host operating system to initiate the container; and provide to the host operating system, from a cache, all data extents needed by the host operating system to initiate the container.
16. A non-transitory computer readable storage medium storing instructions which, when executed, cause a processing device to: identify, by a container initiation optimizer analyzing one or more input/output (I/O) operations associated with a container, one or more data extents that are sufficient for a host operating system to initiate the container, wherein the one or more I/O operations are issued in a production environment; and responsive to a request to initiate the container, provide the one or more data extents to the host operating system, wherein the host operating system can initiate the container based on the one or more data extents without additional portions of a complete dataset for the container being provided to the host operating system.
17. The non-transitory computer readable storage medium of statement 16, wherein the container initiation optimizer includes a file system I/O processing component that processes I/O operations and a file transfer I/O processing component that processes file transfer I/O operations to provide one or more data extents to the host operating system from a container data source; and wherein to provide the one or more data extents, the instructions, when executed, cause the processing device to stream the one or more data extents from the container data source to the host operating system.
18. The non-transitory computer readable storage medium of statement 16 or 17, wherein the instructions, when executed, further cause the processing device to: analyze metadata for the one or more I/O operations to identify the one or more data extents that are sufficient for the host operating system to initiate the container; and associate the identified one or more data extents with the container.
19. The non-transitory computer readable storage medium of any combination of one or more of statements 16-18, wherein the instructions, when executed, further cause the processing device to request the one or more data extents from a container data source in one or more aggregated requests.
20. The non-transitory computer readable storage medium of any combination of one or more of statements 16-19, wherein each of the one or more aggregated requests includes an identification of multiple data extents and each aggregated request is generated based on an aggregated list of the one or more data extents that are sufficient for the host operating system to initiate the container.

Although some embodiments are described largely in the context of a system, method, or in some other way, readers will recognize that embodiments of the present disclosure may also take the form of a computer program product disposed upon computer readable storage media for use with any suitable processing system. Such computer readable storage media may be any storage medium for machine-readable information, including magnetic media, optical media, solid-state media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps described herein as embodied in a computer program product. Persons skilled in the art will recognize also that, although some of the embodiments described in this specification are oriented to software installed and executing on computer hardware, nevertheless, alternative embodiments implemented as firmware or as hardware are well within the scope of the present disclosure.

Readers will appreciate that some embodiments are described in which computer program instructions are executed on computer hardware such as, for example, one or more computer processors. Readers will appreciate that in other embodiments, computer program instructions may be executed on virtualized computer hardware (e.g., one or more virtual machines), in one or more containers, in one or more cloud computing instances (e.g., one or more Azure virtual machine instances), in one or more serverless compute instances offered such as those offered by a cloud services provider, in one or more event-driven compute services such as those offered by a cloud services provider, or in some other execution environment.

In some examples, a non-transitory computer-readable medium storing computer-readable instructions may be provided in accordance with the principles described herein. The instructions, when executed by a processor of a computing device, may direct the processor and/or computing device to perform one or more operations, including one or more of the operations described herein. Such instructions may be stored and/or transmitted using any of a variety of known computer-readable media.

A non-transitory computer-readable medium as referred to herein may include any non-transitory storage medium that participates in providing data (e.g., instructions) that may be read and/or executed by a computing device (e.g., by a processor of a computing device). For example, a non-transitory computer-readable medium may include, but is not limited to, any combination of non-volatile storage media and/or volatile storage media. Exemplary non-volatile storage media include, but are not limited to, read-only memory, flash memory, a solid-state drive, a magnetic storage device (e.g., a hard disk, a floppy disk, magnetic tape, etc.), ferroelectric random-access memory (“RAM”), and an optical disc (e.g., a compact disc, a digital video disc, a Blu-ray disc, etc.). Exemplary volatile storage media include, but are not limited to, RAM (e.g., dynamic RAM).

One or more embodiments may be described herein with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

While particular combinations of various functions and features of the one or more embodiments are expressly described herein, other combinations of these features and functions are likewise possible. The present disclosure is not limited by the particular examples disclosed herein and expressly incorporates these other combinations.

1. A method of accelerating container initiation in a production environment that includes a host system that supports a host operating system, the method comprising:
generating, by a container initiation optimizer analyzing one or more input/output (I/O) operations associated with a container, a profile for the container that identifies one or more data extents that are sufficient for the host operating system to initiate the container, wherein the one or more I/O operations are issued in the production environment; and
responsive to a request to initiate the container, providing the one or more data extents identified in the profile to the host operating system, wherein the host operating system can initiate the container based on the one or more data extents without additional portions of a complete dataset for the container being provided to the host operating system.

2. The method of claim 1, wherein:
the container initiation optimizer includes:
a file system I/O processing component that processes I/O operations; and
a file transfer I/O processing component that processes file transfer I/O operations to provide one or more data extents to the host operating system from a container data source; and
providing the one or more data extents further comprises streaming the one or more data extents from the container data source to the host operating system.

3. The method of claim 1, further comprising:
analyzing metadata for the one or more I/O operations to identify the one or more data extents that are sufficient for the host operating system to initiate the container; and
associating the identified one or more data extents with the container.

4. The method of claim 1 further comprising requesting the one or more data extents from a container data source in one or more aggregated requests.

5. The method of claim 4, wherein each of the one or more aggregated requests includes an identification of multiple data extents and each aggregated request is generated based on an aggregated list of the one or more data extents that are sufficient for the host operating system to initiate the container.

6. The method of claim 1, further comprising prefetching the one or more data extents from a container data source, including storing the one or more data extents in local storage of the host system.

7. The method of claim 1, wherein providing the one or more data extents to the host operating system further comprises:
prefetching, from a container data source, all data extents needed by the host operating system to initiate the container; and
providing to the host operating system, from a cache, all data extents needed by the host operating system to initiate the container.

8. The method of claim 1, further comprising generating an aggregated list of the one or more data extents associated with each of a plurality of containers, wherein different containers of the plurality of containers are associated with different aggregated lists of data extents.

9. An apparatus for accelerating container initiation in a production environment that includes a host system that supports a host operating system, comprising:
a memory; and
a processing device, operatively coupled to the memory, the processing device configured to:
generate, by a container initiation optimizer analyzing one or more input/output (I/O) operations associated with a container, a profile for the container that identifies one or more data extents that are sufficient for the host operating system to initiate the container, wherein the one or more I/O operations are issued in the production environment; and
responsive to a request to initiate the container, provide the one or more data extents identified in the profile to the host operating system, wherein the host operating system can initiate the container based on the one or more data extents without additional portions of a complete dataset for the container being provided to the host operating system.

10. The apparatus of claim 9, wherein:
the container initiation optimizer includes:
a file system I/O processing component that processes I/O operations; and
a file transfer I/O processing component that processes file transfer I/O operations to provide one or more data extents to the host operating system from a container data source; and
wherein to provide the one or more data extents, the processing device is further configured to stream the one or more data extents from the container data source to the host operating system.

11. The apparatus of claim 9, wherein the processing device is configured to:
analyze metadata for the one or more I/O operations to identify the one or more data extents that are sufficient for the host operating system to initiate the container; and
associate the identified one or more data extents with the container.

12. The apparatus of claim 9, wherein the processing device is configured to request the one or more data extents from a container data source in one or more aggregated requests.

13. The apparatus of claim 12, wherein each of the one or more aggregated requests includes an identification of multiple data extents and each aggregated request is generated based on an aggregated list of the one or more data extents that are sufficient for the host operating system to initiate the container.

14. The apparatus of claim 9, wherein the processing device is configured to prefetch the one or more data extents from a container data source, including storing the one or more data extents in local storage of the host system.

15. The apparatus of claim 9, wherein to provide the one or more data extents the processing device is configured to:
prefetch, from a container data source, all data extents needed by the host operating system to initiate the container; and
provide to the host operating system, from a cache, all data extents needed by the host operating system to initiate the container.

16. A non-transitory computer readable storage medium storing instructions which, when executed, cause a processing device to:
generate, by a container initiation optimizer analyzing one or more input/output (I/O) operations associated with a container, a profile for the container that identifies one or more data extents that are sufficient for the host operating system to initiate the container, wherein the one or more I/O operations are issued in the production environment; and
responsive to a request to initiate the container, provide the one or more data extents identified in the profile to the host operating system, wherein the host operating system can initiate the container based on the one or more data extents without additional portions of a complete dataset for the container being provided to the host operating system.

17. The non-transitory computer readable storage medium of claim 16, wherein:
the container initiation optimizer includes:
a file system I/O processing component that processes I/O operations; and
a file transfer I/O processing component that processes file transfer I/O operations to provide one or more data extents to the host operating system from a container data source; and
wherein to provide the one or more data extents, the instructions, when executed, cause the processing device to stream the one or more data extents from the container data source to the host operating system.

18. The non-transitory computer readable storage medium of claim 16, wherein the instructions, when executed, further cause the processing device to:
analyze metadata for the one or more I/O operations to identify the one or more data extents that are sufficient for the host operating system to initiate the container; and
associate the identified one or more data extents with the container.

19. The non-transitory computer readable storage medium of claim 16, wherein the instructions, when executed, further cause the processing device to request the one or more data extents from a container data source in one or more aggregated requests.

20. The non-transitory computer readable storage medium of claim 19, wherein each of the one or more aggregated requests includes an identification of multiple data extents and each aggregated request is generated based on an aggregated list of the one or more data extents that are sufficient for the host operating system to initiate the container.
